(19) United States
(12) Patent Application Publication
(10) Pub. No.: US 2010/0325878 A1
(43) Pub. Date: Dec. 30, 2010

(54) Bi Containing Solid Oxide Fuel Cell System With Improved Performance and Reduced Manufacturing Costs

(76) Inventors: Gong Zhang, Murrysville, PA (US); Roswell J. Ruka, Pittsburgh, PA (US); Chun Lu, Monroeville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/490,495

(22) Filed: Jun. 24, 2009

(51) Int. Cl. H01M 4/82

(52) U.S. Cl. 29/623.5

(57) ABSTRACT

A method to provide a tubular, triangular or other type solid oxide electrolyte fuel cell has steps including providing a porous air electrode cathode support substrate, applying a solid electrolyte and cell to cell interconnection on the air electrode, applying a layer of bismuth compounds on the surface of the electrolyte and possibly also the interconnection, and sintering the whole above the melting point of the bismuth compounds for the bismuth compounds to permeate and for densification.

### GOVERNMENT CONTRACT

The Government of the United States of America has rights in this invention pursuant to Contract No. DE-FC26-05NT42613, awarded by the U.S. Department of Energy.

### BACKGROUND OF THE INVENTION

1. Field of the Invention

This invention relates to interlayer and electrolyte enhancement of electrolyte for tubular and delta solid oxide electrolyte fuel cells (SOFC).

2. Description of the Prior Art

High temperature solid oxide electrolyte fuel cells (SOFC) have demonstrated the potential for high efficiency and low pollution in power generation. Successful operation of SOFCs for power generation has been limited in the past to temperatures of around 900-1,000° C., due to insufficient electrical conduction of the electrolyte and high air electrode polarization loss at lower temperatures. U.S. Pat. Nos. 4,490,444 and 5,916,700 (Isenberg and Ruka et al. respectively) disclose one type of standard, solid oxide tubular elongated, hollow type fuel cells, which could operate at the above described relatively high temperatures. In addition to large-scale power generation, SOFCs which could operate at lower temperatures would be useful in additional applications such as auxiliary power units, residential power units and in powering light-duty vehicles.

Solid oxide electrolyte fuel cell (SOFC) generators that are based on the patents above, are constructed in such a way as not to require an absolute seal between the oxidant and the fuel streams, and presently use closed ended fuel cells of circular cross section. One example is shown in FIG. 1 of the drawings. Air flows inside the tubes and fuel flows outside. Air passes through a ceramic feed tube, exits at the end and reverses flow to react with the inner fuel cell ceramic air electrode. In these cells, interconnection, electrolyte and fuel electrode layers are deposited on an extruded and sintered, hollow, porous, lanthanum manganite air electrode tube formerly by vapor halide deposition as taught by Isenberg et al. (U.S. Pat. No. 4,547,437) but now by plasma spray or other techniques.

In some instances, to improve low temperature operation, an interfacial layer of terbia-stabilized zirconia is produced between the air electrode and electrolyte where the interfacial layer provides a barrier controlling interaction between the air electrolyte as taught by Baozhen and Ruka (U.S. Pat. No. 5,993,989). The interfacial material is a separate layer completely surrounding the air electrode and is substantially chemically inert to the air electrode and electrolyte and is a good electronic and oxide ionic mixed conductor. Its chemical formula is Zr_{1-x-y}YₓTb_{y}O. Also, U.S. Pat. No. 5,629,103 (Wersing et al.) teaches an interlayer between an electrolyte layer and an electrode layer in SOFC planar multilayer designs. The interlayer is a discrete/separate layer selected from either titanium or niobium doped zirconium oxide or niobium or gadolinium doped cerium oxide of from 1 micrometer to 3 micrometers thick.

FIG. 1 shows a prior art tubular solid oxide fuel cell 10, which operates primarily the same as the other designs that are discussed later but will be described here in some detail, because of its simplicity, and because its operating characteristics are universal and similar to both flattened and tubular, elongated hollow structured fuel cells such as triangular and delta SOFC's. Most components and materials described for this SOFC will be the same for the other type fuel cells shown in the figures. A preferred SOFC configuration has been based upon a fuel cell system in which a gaseous fuel F, such as reformed pipeline natural gas, hydrogen or carbon monoxide, is directed axially over the outside of the fuel cell, as indicated by the arrow F. A gaseous oxidant, such as air or oxygen O, is fed preferably through an air/oxidant feed tube, here called air feed tube 12, positioned within the annulus 13 of the fuel cell, and extending near the closed end of the fuel cell, and then out of the air feed tube back down the fuel cell axially over the inside wall of the fuel cell, while reacting to form depleted gaseous oxygen, as indicated by the arrow O′ as is well known in the art.

In FIG. 1, the air electrode 14 may have a typical thickness of about 1 to 3 mm. The air electrode 14 can comprise doped lanthanum manganite having an ABO₃ perovskite-like crystal structure, which is extruded or isostatically pressed into tubular shape or disposed on a support structure and then sintered.

Surrounding most of the outer periphery of the air electrode 14 is a layer of a dense, solid electrolyte 16, which is gas tight and dense, but oxygen ion permeable/conductive, typically made of scandia- or yttria-stabilized zirconia. The solid electrolyte 16 is typically about 1 micrometer to 100 micrometers (0.001 to 0.1 mm) thick, and can be deposited onto the air electrode 14 by conventional deposition techniques.

In the prior art design, a selected radial segment 20 of the air electrode 14, preferably extending along the entire active cell length, is masked during fabrication of the solid electrolyte, and is covered by a interconnection 22, which is thin, dense and gas-tight provides an electrical contacting area to an adjacent cell (not shown) or to a power contact (not shown). The interconnection 22 is typically made of lanthanum chromite (LaCrO₃) doped with calcium, barium, strontium, magnesium or cobalt. The interconnection 22 is roughly similar in thickness to the solid electrolyte 16. An electrically conductive top layer 24 is also shown.

Surrounding the remainder of the outer periphery of the tubular solid oxide fuel cell 10, on top of the solid electrolyte 16, except at the interconnection area, is a fuel electrode 18 (or anode), which is in contact with the fuel during operation of the cell. The fuel electrode 18 is a thin, electrically conductive, porous structure, typically made in the past of nickel-zirconia or cobalt-zirconia cermet approximately 0.03 to 0.1 mm thick. As shown, the solid electrolyte 16 and fuel electrode 18 are discontinuous, with the fuel electrode being spaced-apart from the interconnection 22 to avoid direct electrical contact.

Referring now to FIG. 2, a prior art, very high power density solid oxide fuel cell stack is shown. The cells are triangular solid oxide fuel cells 30. Here the air electrode 34 has the geometric form of a number of integrally connected elements of triangular cross section. The air electrode can be made of modified lanthanum manganite. The resulting overall cross section has a flat face on one side and a multi-faceted face on the other side. Oxidant as air 0 flows within the discrete passages of triangular shape as shown. An interconnection 32 generally of lanthanum chromite covers the flat face. A solid electrolyte covers the multifaceted face and overlaps the edges of the interconnection 32 but leaves most of the interconnection exposed. The fuel electrode 38 covers the reverse side from the flat face and covers most of the electrolyte but leaves a narrow margin of electrolyte between the interconnection and the fuel electrode. Fuel F will contact the fuel electrode 34. Nickel/yttria stabilized zirconia is generally used as the fuel electrode which covers the reverse side. Series electrical connection between cells is accomplished by means of an electrically conductive top layer 35 of flat nickel felt or nickel foam panel one face of which is sintered to the interconnection while the other face contacts the apexes of the triangular multifaceted fuel electrode face of the adjacent cell. An example of a dimension is width 36—about 100 mm and cell plate thickness—about 8.5 mm. This triangular cell design is active throughout its entire length.

These triangular, elongated, hollow cells have been referred to in some instances as Delta X cells where Delta is derived from the triangular shape of the elements and X is the number of elements. These type cells are described for example in basic, Argonne Labs U.S. Pat. No. 4,476,198; and also in U.S. Pat. No. 4,874,678; and U.S. Patent Application Publication U.S. 2008/0003478 A1 (Ackerman et al., Reichner; and Greiner et al., respectively).

In U.S. Pat. No. 5,516,597 (Singh et al.) an interlayer is provided between the air electrode and the interconnect only to minimize interdiffusion between those components. Its chemical composition is NbₓTa_{y}Ce_{1-x-y}O_{z}. This interlayer is a discrete/separate layer from 0.001 mm to 0.005 mm thick.

N. Q. Minh in J. Am. Ceram. Soc., 76[3]563-88, 1993, “Ceramic Fuel Cells” provides a comprehensive summary of pre 1993 SOFC technology, describing the SOFC components of both tubular and “delta” coflow cells. In the section on “Materials for Cell Components—Electrolyte”, pp. 564-567, the standard yttria-stabilized zirconia (YSZ) electrolyte is discussed as it possesses an adequate level of oxygen-ion conductivity and stability in both oxidizing and reducing atmospheres. The most common stabilizers for zirconia to increase ionic conductivity include, generally, Y₂O₃, CaO, MgO and Sc₂O₃. These doped zirconia electrolytes generally operate at about 800° C. to 1,000° C. because lower temperatures require very thin electrolyte to provide high conductivitance and high surface area interlayer between the electrolyte and the electrode to provide lower polarizations. Other electrolytes mentioned by Minh include stabilized bismuth oxide (Bi₂O₃) which has greater ionic conductivity than YSZ, pp. 566-567. Its main drawback is smaller oxygen partial pressure range of ionic conduction, and concludes “that practical use of stabilized Bi₂O₃ if a SOFC electrolyte is questionable.”

Other tubular, elongated, hollow fuel cell structures are described by Isenberg in U.S. Pat. No. 4,728,584—“corrugated design” and by Greiner et al.—“triangular”, “quadrilateral”, “oval”, “stepped triangle” and a “meander”; all herein considered as hollow elongated tubes.

As described previously, the hollow, porous air electrode is extruded or otherwise formed, generally of modified lanthanium manganite and then sintered. Then an interconnection, to other fuel cells, in narrow strip form is deposited over the length of the air electrode and then heated to densify. Then onto the sintered air electrode with attached densified interconnection an electrolyte is applied, generally by hot plasma spraying, where the electrolyte, generally ytrria stabilized zirconia is applied over the air electrode to contact or overlap the edges of the narrow, densified interconnection strip. Then the electrolyte is also densified by heating.

Presently, electrolyte densification occurs at about 1,300° C.-1,400° C. for 10-20 hours to ensure the electrolyte gas tightness. Such aggressive densification condition, however, reduces interlayer porosity and promotes undesired interconnection reactions, which leads to loss of reaction sites, catalytic activities, and ultimately cell performance. The high temperature also promotes the high-temperature leak due to Mn diffusion in the electrolyte, shortens the lifetime of the sintering furnace, and lengthens the cell manufacturing cycle. Also, in order to obtain low electrolyte leak rate after electrolyte densification, high-power plasma arc spraying is necessary to achieve a decent initial green electrolyte density before densification. Using high power to generate high-speed, high-temperature plumes, however, tends to break cells and generate crazing during plasma spray due to the high mechanical and thermal stresses imposed on the cells. Cells with asymmetric geometry, such as delta cells are particularly vulnerable to these processes significantly lowering the yield. The plasma arc spray process also imposes stringent requirements on the accuracy and precision of cell geometry, especially those cells with complex shapes such as delta cells. Subtle changes in cell contour will result in complex spraying gun control and programming, increased cell manufacturing cycle and costs, and higher electrolyte powder consumption.

Plasma arc spraying and flame spraying, i.e., thermal spraying or plasma spraying, are known film depositions techniques. Plasma spraying involves spraying a molten powdered metal or metal oxide onto the surface of a substrate using a thermal or plasma spray gun. U.S. Pat. No. 4,049,841 (Coker, et al.) generally teaches plasma and flame spraying techniques. Plasma spraying has been used for the fabrication of a variety of SOFC components. Plasma spraying, however, has been difficult in the fabrication of dense interconnection material.

A method is needed to help eliminate electrolyte microcracks, reduce electrolyte thickness below the current 60 micrometer to 80 micrometer thickness thus reducing expensive electrolyte powder costs and reduce temperatures below 1,200° C., saving electrical costs, Mn diffusion, and furnace life, and if possible, eliminate plasma spraying altogether.

It is therefore a main object of this invention to reduce manufacturing costs, electrolyte and IC thickness and densification temperatures and time, and improve cell performance.

It is also an object of this invention to at least reduce role of plasma spraying techniques and to provide a process that is more commercially feasible.

### SUMMARY OF THE INVENTION

The above needs are supplied and objects accomplished by providing a method of making a hollow, elongated tubular fuel cell by the steps: (a) providing a porous elongated, hollow tubular air electrode cathode support substrate for a solid oxide fuel cell; (b) applying a solid oxide electrolyte and interconnection in porous unsintered form on the air electrode to provide a composite; (c) applying a layer of bismuth compounds on the surface of the electrolyte and interconnection composite; and (d) sintering the composite above the melting point of the bismuth compounds for the bismuth compounds to permeate through the solid electrolyte and interconnection for densification. Additionally, an interlayer of bismuth compound can be applied to the air electrode first, before application of the electrolyte. The preferred bismuth compound is in an aqueous medium of Bi₂O₃ such as an aqueous suspension of Bi₂O₃. Preferably, plasma spraying is not used to apply the electrolyte.

The use of infiltrated bismuth compounds can: allow both electrolyte and interconnection (IC) densification at lower temperatures; allow elimination of plasma spraying techniques; reduce cell kinetics resistance; eliminate microcracks in the electrolyte allowing reduced electrolyte thickness; and they can function as a sintering agent to lower electrolyte densification temperature.

As used herein, “tubular, elongated, hollow” solid oxide fuel cells is defined to include: triangular, that is wave type; sinusoidally shaped wave; alternately inverted triangular folded shape; corrugated; delta; Delta; square; oval; stepped triangle; quadrilateral; and meander configurations, all known in the art.

### BRIEF DESCRIPTION OF THE DRAWINGS

The invention will become more readily apparent from the following description of preferred embodiments thereof shown, by way of example only, in the accompanying drawings, wherein:

FIG. 1 is a sectional perspective view of one type prior art tubular solid oxide fuel cell showing an air feed tube in its center volume;

FIG. 2 is a sectional perspective view of one type prior art delta triangular, solid oxide fuel cell stack of two sets of fuel cells, showing oxidant and fuel flow paths but not air feed tubes for sake of simplicity;

FIG. 3 is a schematic flow diagram of one embodiment of the process of this invention;

FIG. 4 is a cross-section view of one embodiment of an infiltrated/impregnated SOFC electrolyte with possible interlayer formation;

FIG. 5A is a current density vs. cell voltage graph showing comparative performances of Bi₂O₃ infusion vs. non-Bi₂O₃ infusion at 900° C.;

FIG. 5B is a current density vs. cell voltage graph showing comparative performances of Bi₂O₃ infusion vs. non-Bi₂O₃ infusion at 700° C.; and

FIG. 5C is a current density vs. cell voltage graph showing comparative performances of Bi₂O₃ infusion vs. non-Bi₂O₃ infusion at various temperatures.

### DESCRIPTION OF THE PREFERRED EMBODIMENTS

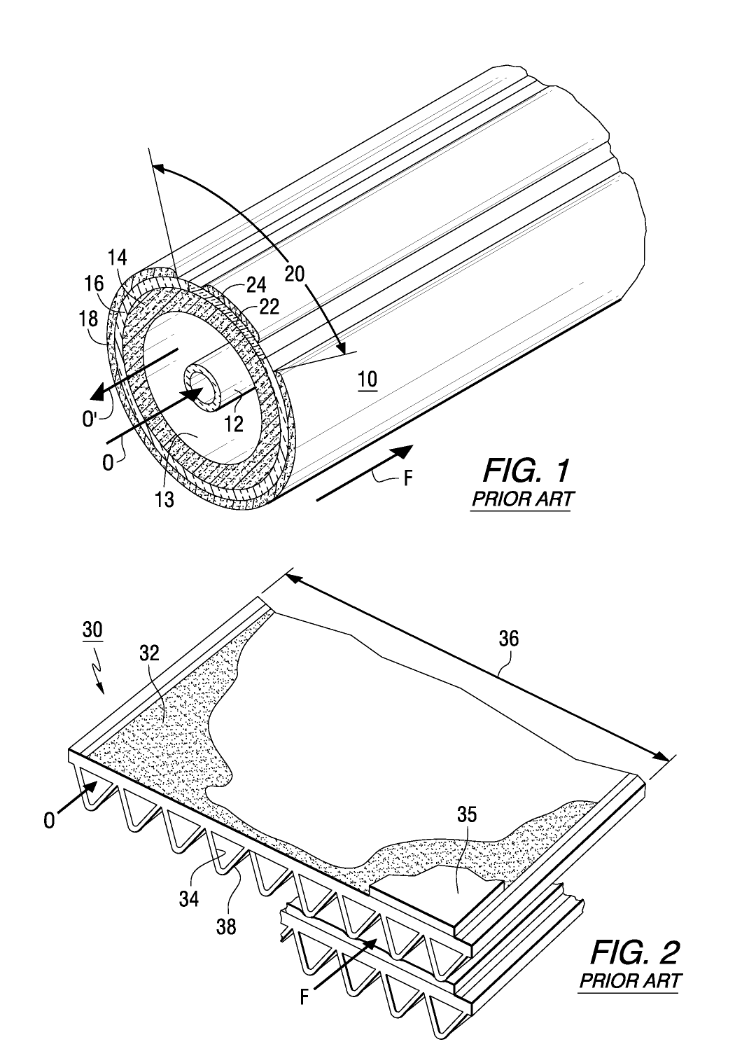

It has been found that adding Bismuth compounds to the electrolyte in the FIG. 1 and FIG. 2 solid oxide fuel cells, will enhance cell performance. The electrolyte in all fuel cells is disposed between the inner air electrolyte and the outer fuel electrode. It has been found that, in particular, Bi₂O₃ is an excellent oxygen ion conductor whose oxygen ionic conductivity is 2 orders of magnitude higher than ScSZ at 750° C. and is a good catalyst for oxygen reduction. Its presence near or at the air electrode-electrolyte interface or as a very thin, 1 to 50 micrometer discrete interlayer between electrolyte and air electrode will reduce cell kinetics resistance especially at lower temperatures so that enhanced cell performance is expected in terms of cell voltage vs. current density. More than 100 mV improvement at 700° C. has been demonstrated at 100 mA/cm².

Also, Bi₂O₃ is effective to eliminate microcracks in the electrolyte, so that electrolyte thickness can be readily reduced from the present 60-80 micrometers (0.06 mm-0.08 mm) to 20-40 micrometers (0.020 mm-0.04 mm) or less, as detailed below. Cell performance can be further improved as a result of decreased ohmic resistance of a thinner electrolyte, plus substantial savings of expensive electrolyte material will be realized.

Bismuth compounds usually as an aqueous solution or suspension, can be introduced by means of an infiltration process, that is the bismuth compounds are deposited into the surface of the substrate under vacuum. In one method, the BiO₂ infiltration process occurs after the electrolyte is plasma sprayed (before densification). For the bismuth compounds infiltration process to succeed, the as-sprayed electrolyte needs to remain porous to effectively pick up bismuth compounds from a suspension. As a result, plasma spraying can be carried out using moderate power conditions so that cells, which otherwise would have failed during high-power settings, can survive. More important, fewer cell damage and higher yield are expected compared with the current high power plasma spraying process, particularly for Delta cells. At the same time, the mild spraying conditions will greatly lengthen the life of plasma spraying hardware.

As successfully demonstrated in the sections below, bismuth compounds addition allows the fabrication of a thinner electrolyte of 30-40 micrometers thick, half that of current electrolyte. This translates into an instant cost saving of ˜50% electrolyte powder, which is one of the most expensive raw materials in the SOFC.

Bi₂O₃ also functions as a sintering aid during the initial electrolyte densification process to lower the electrolyte densification temperature. The gas tight electrolyte can be obtained between just above the melting point of bismuth oxide (817° C. to 1,100° C. for up to six hours (vs. usual 1,345° C. for 17 hours), which saves cell manufacturing cost and, more importantly, improves interlayer and cell performance.

Current manufacturing processes can be potentially replaced by alternate, cost-effective techniques with the aid of Bi₂O₃, which will make the electrolyte fabrication step more tolerant to cell geometry and cell strength. The success in this area will potentially drastically reduce costs. Besides suspension of Bi₂O₃, other useful bismuth compounds include those that can thermally decompose into bismuth oxides with lower melting points.

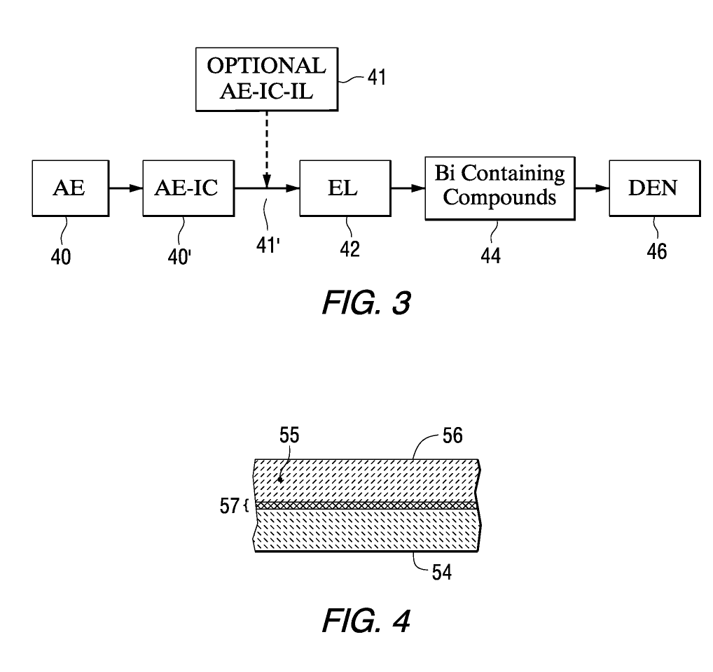

As shown in FIG. 3, the process starts with air electrode (AE) tubes, which can be with an interconnection (IC) 40′, which IC may be pre-densified. Then the tubes are processed according to normal cell processing procedures until scandia stabilized zirconia (ScSZ) electrolytes (EL) is applied, usually plasma-sprayed, without sintering 42. It is particularly important not to densify the electrolyte at this point so that the Bi₂O₃ suspension can flow into and through the porous structure in later steps. The as-sprayed tubes are then vacuum-infiltrated in a Bi-containing compound such as a Bi₂O₃ suspension, for about 1-5 minutes, to achieve a certain Bi₂O₃ weight pickup 44. Upon drying for 10-14 hours, the electrolyte is sintered at from 820° C.-1,100° C. for 4 up to 6 hours for electrolyte and possible interconnection densification (DEN) 46.

FIG. 4 shows the resulting structure in simplified cross-section. Prepared porous ceramic air electrode tube 54, with possible densified interconnection (not shown) are coated with porous electrolyte ceramic 56. Bi-containing compound, such as Bi₂O₃, will be used for infiltration at room temperature with solid particle size up to 50 micron, preferably submicron particles, shown as aqueous suspension 55. This suspension is infiltrated onto at least the porous, non-densified electrolyte to impregnate the electrolyte and possibly pass into the very top of the porous air electrode to form a type interlayer (IL) 57 upon densification as shown.

It is envisioned that a dense electrolyte (EL) can be produced without employment of plasma spray at all but with the aid of applied Bi containing compound by following a procedure schematically depicted by utilizing step 41 at point 41′ in FIG. 4. An electrode 40 or 40′ is coated with a Bi₂O₃ interlayer 41 at step 41′ between steps 40 or 40′ and 42, and then subsequently coated with a porous electrolyte layer 42 using processing techniques that, compared with plasma spray, are more cost-effective and more tolerant to cell geometry variation. The processing techniques include, but are not limited to, roller coating, dip coating, powder spray coating, casting and infiltration. The green electrolyte layer can be heat-treated, if necessary, to achieve an optimal porous structure for the following Bi₂O₃ infiltration process 44. The Bi oxide is then applied to the formed porous EL and the whole sample is heat treated. During the treatment bismuth oxide facilitates the densification of pre-formed porous electrolyte (EL), while the pre-existing pores in the electrolyte (EL) serve as “sink” to confine the applied Bi oxide inside the electrolyte without substantially interrupting interlayer microstructures and chemistry. As a result, high-performance low-cost cells are manufactured without using the plasma spray technique.

### EXAMPLES

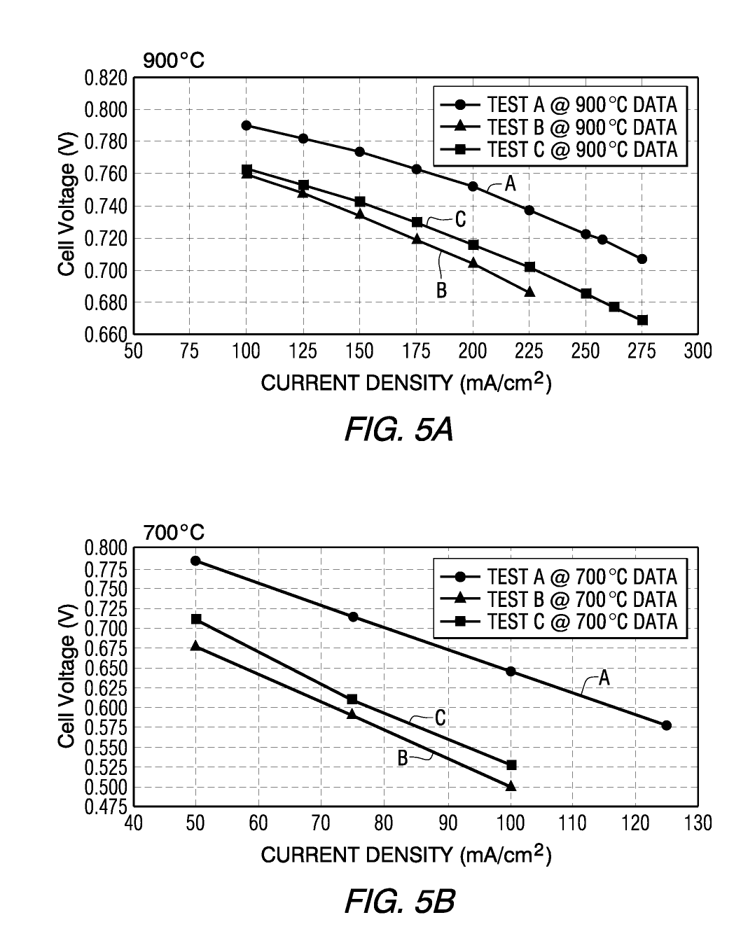

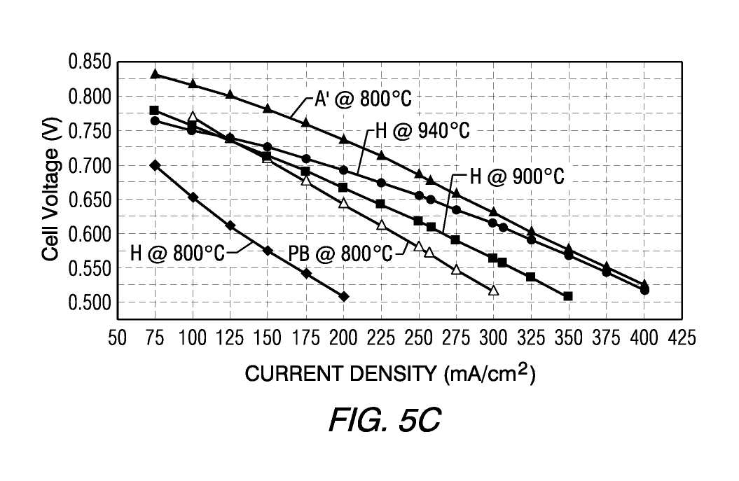

Test Cell A having a modified lanthanum manganite air electrode was plasma sprayed with scandia stabilized zirconia (ScSZ) to provide a “green” porous electrolyte coating. The electrolyte coating was then infiltrated/impregnated with aqueous Bi₂O₃ suspension at room temperature for about two minutes. Then the whole structure was heated to 1,050° C. for six hours to densify the electrolyte and IC. Cells B and C, the same as Cell A, were not infiltrated/impregnated with Bi₂O₃. FIGS. 5A-B show test results of Cells A, B and C with current density (mA/cm²) vs. cell voltage (V) at 900° C. and 700° C. Clearly, Cell (Test) A shows that Bi₂O₃ inclusion in the electrolyte helps cell performance vs. Cells (Tests) B and C with no Bi₂O₃. The improvement is more than 30 mV at 900° C. and 200 mA/cm² and increases as temperature goes down. At 700° C. and 100 mA/cm², for example, cell voltages improved 140 mV. The improvement is mainly attributed to the kinetic enhancement at the electrolyte interlayer interface due to the presence of Bi compounds. In addition, overall cell ohmic resistance was reduced by about 30% at 700° C.

To further test Bi-containing cell performance, the ScSZ electrolyte thickness was reduced by approximately 50% to ˜35 micrometers. The resultant Cell A′ having a base air electrode, Bi-containing composite interlayer, Bi-infiltrated ScSZ electrolyte, and Ni-doped ZrO₂ iron cermet fuel electrode, displayed dramatically improved performance. As suggested in FIG. 5(C), for example, the Bi-containing cell easily outperformed the present best cells at 800° C. and showed 107 mV higher than the Cell A′ of the invention, under a current density of 258 mA/cm² (corresponding to 70 A current). Under the same current density its 800° C. performance even exceeds H experimental cells at 940° C. by 29 mV. Under current density of 258 mA/cm², the Bi-containing cell at 900° C. is 44 mV higher than the present best cell at the same temperature, and 83 mV higher than the H cell at 1,000° C. The performance improvement is more pronounced at 700° C.

The excellent performance of Bi-containing cells will increase the electrical efficiency of present SOFC systems. Also, it will enable a SOFC system to be operated at reduced temperature peaking in the vicinity of 800° C., roughly 200° C. lower than the current system. Such a technical progress will dramatically reduce cell and module costs and improve system durability. In addition, reduced temperature operation is essential for on-cell reformation, high temperature leak mitigation, and low-temperature electrical current loading during system startup. FIG. 5C shows these results where the Bi₂O₃-containing cell is A′, the present best cells are labeled PB and the H experimental cells are labeled H.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A method of forming a hollow, elongated tubular solid oxide electrolyte fuel cell composite by the steps of:
(a) providing a porous hollow elongated tubular air electrode cathode support substrate for a solid oxide fuel cell;
(b) applying a solid oxide electrolyte and interconnection in porous unsintered form on the air electrode to provide a composite;
(c) applying a layer of bismuth compounds on surface of electrolyte and interconnection composite; and
(d) sintering the composite above the melting point of the bismuth compounds for the bismuth compounds to permeate through the solid electrolyte and interconnection for densification.

2. The method of claim 1, wherein the bismuth compounds are selected from compounds that decompose into oxides on heating.

3. The method of claim 1, wherein the bismuth compound is Bi₂O₃.

4. The method of claim 1, wherein the bismuth compound is applied as a suspension in an aqueous medium.

5. The method of claim 1, wherein plasma spraying is not used in step (b).

6. The method of claim 1, wherein an interlayer of bismuth compound is optionally applied to the air electrode first, before step (b).

7. The method of claim 1, wherein both electrolyte and interconnection can be densified at lower temperatures because of the use of the bismuth compounds.

8. The method of claim 1, wherein both electrolyte and interconnection can be densified other than using the plasma spray technique because of the use of the bismuth compounds.

9. The method of claim 1, wherein the applied bismuth compounds reduce cell kinetics resistance to provide enhanced cell performance in terms of cell voltage vs. current density.

10. The method of claim 1, wherein the applied bismuth compounds are effective to eliminate microcracks in the electrolyte allowing the electrolyte thickness to be reduced to 20 micrometers to 40 micrometers.

11. The method of claim 1, wherein the applied bismuth compounds provide decreased electrolyte thickness, and wherein the bismuth ohmic resistance compound is applied in step (c) by infiltrating through the porous electrolyte.

12. The method of claim 1, wherein the applied bismuth compounds function as a sintering aid to lower electrolyte densification temperature in step (d).

13. The method of claim 1, wherein as a final step the electrolyte is leak checked.

14. The method of claim 11, wherein the infiltration is vacuum infiltration.
